(19) United States
(12) Patent Application Publication
(10) Pub. No.: US 2005/0069726 A1
(43) Pub. Date: Mar. 31, 2005

(54) Light emitting composite material and devices thereof

(76) Inventors: Elliot Paul Douglas, Gainesville, FL (US); Shyh-Chyang Luo, Gainesville, FL (US)

Correspondence Address: Akerman Senterfitt, 4th Floor, 222 Lakeview Avenue, West Palm Beach, FL, 33401-6147, US

(21) Appl. No.: 10/675,192

(22) Filed: Sep. 30, 2003

(51) Int. Cl. H05B 33/14; C09K 11/06; C09K 11/54

(52) U.S. Cl. 428/690; 428/917; 428/323; 313/504; 313/506; 257/89; 252/301.35; 252/301.16; 252/301.6 R

(57) ABSTRACT

A light emitting composite arrangement and related device includes an electroluminescent polymer material which emits ultraviolet light and a plurality of photoluminescent nanoparticles energetically coupled to the polymer. The arrangement and device emits red-shifted light relative to the ultraviolet light. Through use of different size nanoparticles, different colors can be provided, such as in pixelized form.

### CROSS-REFERENCE TO RELATED APPLICATIONS

Not applicable.

### STATEMENT REGARDING FEDERALLY SPONSORED RESEARCH OR DEVELOPMENT

Not applicable

### FIELD OF THE INVENTION

This invention relates generally to polymer-based light emitting devices, materials and methods for making the same.

### BACKGROUND OF THE INVENTION

Electroluminescent polymers are polymers which convert electrical energy into light. Very few polymers show electroluminescence and even fewer have useful efficiencies. This group of polymers have distinct advantages over similar inorganic materials in that they are light, flexible, and relatively easily fabricated. A great deal of interest has been focused on electroluminescent polymers because of the relatively low driving voltage and improved brightness, and emission efficiency. These polymers also have a distinct advantage in fabrication, as they can be manipulated according to known polymer processing techniques and can be patterned onto an electrode with photolithography. Such processing techniques include spin-casting.

Electroluminescent polymers typically emit light at a particular wavelength. Certain polymers, such as some polysilanes, are known to emit light that is in the near UV range. If different wavelengths of emitted light are desired, it is possible to use different polymers, such as a first polymer in certain pixels and another polymer in other pixels. However, different polymers generally require different synthesis routes which increases the difficulty and expense of fabrication. In addition, different polymers can have significantly different stabilities. If a given device is made from several different polymers, the differing stabilities can result in the respective colors fading unevenly. Accordingly, there is a need for a polymer-based material which can emit different wavelengths of light without fundamental process or material changes.

### SUMMARY OF THE INVENTION

A light emitting composite arrangement includes an electroluminescent polymer material which emits ultraviolet light and a plurality of photoluminescent nanoparticles energetically coupled to the polymer. The arrangement emits red-shifted light relative to the ultraviolet light. As used herein, the phrase “energetically coupled” refers to physical proximity between the polymer and the nanoparticles such that ultraviolet light energy emitted by the polymer is transferred to the nanoparticles. The electroluminescent polymer can be a polysilane, such as a substituted polysilane selected from the group consisting of monoalkyl polysilanes, dialkyl polysilanes, monoalkyl-aryl polysilanes, monoaryl polysilanes, and diaryl polysilanes.

The nanoparticles can have sizes in the range of between 1-10 nm and can comprise any light emitting crystal. For example, the nanoparticles can be selected from group IV crystals (e.g. Si or Ge), group III-V crystals (e.g. GaAs), or group II-VI crystals (e.g. CdSe, ZnS, ZnSe, ZnTe, CdS or CdTe). The nanoparticles can be intermixed with the polymer, or provided in a layer separate from the polymer. In one embodiment, the nanoparticles comprise core-shell particles. For example, core shell particles can comprise all combinations of cores selected from ZnS, ZnSe, ZnTe, CdS, CdSe and CdTe and shells selected from the same group. The composite can comprise at least one of a hole transport layer and an electron transport layer, the energy transport layer being energetically coupled to the electroluminescent polymer.

A light emitting device comprises an anode, a cathode, and a light emitting composite arrangement disposed between the anode and the cathode. The composite includes an electroluminescent polymer material which emits ultraviolet light when electrically stimulated, and a plurality of photoluminescent nanoparticles energetically coupled to the polymer, the device emitting red-shifted light relative to the ultraviolet light. The device can include a hole transport layer between the polymer and the anode and an electron transport layer disposed between the polymer and the cathode. At least a portion of the nanoparticles can be disposed in the hole transport layer or the electron transport layer. The anode can comprise indium tin oxide (ITO) and the cathode can comprise Ca, Al or Mg/Ag. Mg/Ag is preferably provided in a weight ratio of around 10:1. In one embodiment, the device provides a plurality of pixels, such as red, green and blue pixels.

### BRIEF DESCRIPTION OF THE DRAWINGS

There is shown in the drawings embodiments which are presently preferred, it being understood, however, that the invention is not limited to the precise arrangements and instrumentalities shown, wherein:

FIG. 1 is a depiction of a light emitting polymer-based composite material, according to the invention.

FIG. 2 is a schematic depiction of a light emitting device including the light emitting composite material of the invention.

FIG. 3 is a schematic depiction of a light emitting device including separate electroluminescent, nanoparticle and hole transport layers, according to an embodiment of the invention.

FIG. 4 is a schematic depiction of a pixelated light emitting device according to another embodiment of the invention.

### DETAILED DESCRIPTION OF THE INVENTION

According to one embodiment of the invention, a light emitting composite arrangement is shown in FIG. 1. The light emitting composite arrangement 10 comprises a polymer matrix 12 that is formed from an electroluminescent polymer which emits ultraviolet light in response to electrical stimulation. A plurality of photoluminescent nanoparticles 14 in polymer 12 receive energy from the stimulated electroluminescent polymer. The nanoparticles 14 provide strong absorption of ultraviolet light. The photoluminescent particles 14 then emit light at a red-shifted wavelength, relative to the ultraviolet light emitted by the polymer, such as visible light. As used herein, the term “light” refers to visible light, as well as ultraviolet or infrared light, unless stated otherwise.

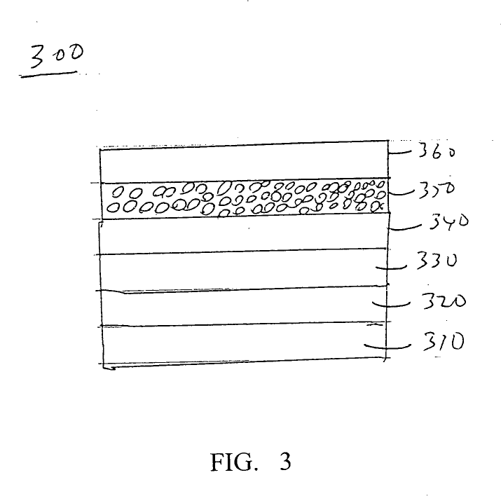

Although not seeking to be bound by the theoretical basis of the operation of the invention, a simple description where the electroluminescent polymer 12 first undergoes electroluminescence, resulting in absorption of that light by the nanoparticles 14 which then undergo photoluminescence may understate the complexity of the mechanism(s) involved. The energy transfer mechanism may include Forster energy transfer, or process referred to as trapping, particularly when the nanoparticles 14 are intermixed with polymer 12 as shown in FIG. 1. However, when the nanoparticles 14 are remote from polymer 12, such as in separate layers (see FIG. 3), the energy transfer mechanism can include the nanoparticles 14 simply directly absorbing light emitted by polymer 12.

The electroluminescent polymer 12 is typically a conjugated polymer, such as a σ bonded polymer. Such polymers include certain polysilanes which are electroluminescent in the ultraviolet, such as monoalkyl polysilanes, dialkyl polysilanes, monoalkyl-aryl polysilanes, monoaryl polysilanes, and diaryl polysilanes. Polymers including germanium as opposed to silicon or in addition to silicon may also provide emissions in the ultraviolet since such germanium comprising polymers have been reported to have properties similar to polysilanes.

Other examples of electroluminescent polymers include poly(1,4-phenylene vinylene), poly[(2-methoxy-5-(2′-ethyl hexyloxy)-1,4-phenylene) vinylene], and poly (3 hexyl thiophene). These non-polysilane polymers are generally only visible light emitting, not ultraviolet emitting. However, through structural manipulation of these or other polymers, electroluminescent ultraviolet emissions may be possible.

As shown in FIG. 1, nanoparticles are intermixed with polymer 12. However, as discussed relative to FIG. 3, nanoparticles 14 can be in a separate layer from polymer 12. In the mixed layer embodiment shown in FIG. 1, the concentration of nanoparticles 14 is generally from 1 to 10% by weight of the nanoparticle/polymer composite.

An advantage of the invention is that the light emitted by the light emitting composite material 10 can be controlled by appropriate selection of photoluminescent particle sizes and particle material during the fabrication process. Sizes for the photoluminescent particles generally range from about 1 to 10 nm.

Photoluminescent nanoparticles 14 are generally semiconductor nanocrystals. The physics and optics of photoluminescent nanocrystals have been studied to characterize the dramatic change in the optical properties of the nanocrystal as a function of its size. As the size of the nanocrystal decreases, the electronic excitations shift to higher energies (lower wavelengths) due to quantum confinement effects, leading to the observed changes in the optical properties. The physical size of nanocrystals begins to have an effect on the optical properties around 10 nm for silicon nanocrystals, but will vary for other nanocrystal materials. For nanocrystals below about 10 nm in size, it is well known that the emission becomes a function of their size.

There are several known alternative nanocrystal materials to Si nanocrystals which have been shown to photoluminesce. It is known that Ge luminesces in a variety of materials. For example Y. Maeda, Phys. Rev. B 51 (1995) 1658, or K. S. Min et al, Appl. Phys. Lett 68 (1996) 2511 reports Ge luminescencing in SiO₂. GaAs is also known to luminesce in several materials. Other nanocrystal materials that have been demonstrated to be photoluminescent candidates include other semiconductor compounds, such as CdSe or ZnS.

The photoluminescent emissions can also be controlled with the use of different morphologies for the nanocrystal. For example, a composite nanoparticle can comprise a core made from one nanocrystal material coated with a shell of a second material, referred to herein as core-shell particles. Core shell particles can comprise all combinations of cores selected from ZnS, ZnSe, ZnTe, CdS, CdSe and CdTe and shells selected from the same group. In another embodiment, the outer layers of nanocrystal (e.g. Si) can be an oxide layer.

Since the wavelength of light emitted by the photoluminescent particles 14 generally changes with the size of the particles, the wavelength or average wavelength emitted by the light emitting material 10 can easily be adjusted during fabrication by varying the size range of the photoluminescent particles 14 that are included in composite material 10. Alternatively, the light emitted by composite material 10 can be adjusted by mixing photoluminescent particles 14 of different materials and/or different quantities of different particles. The same electroluminescent polymer and thus the same polymer fabrication methods can be employed if desired.

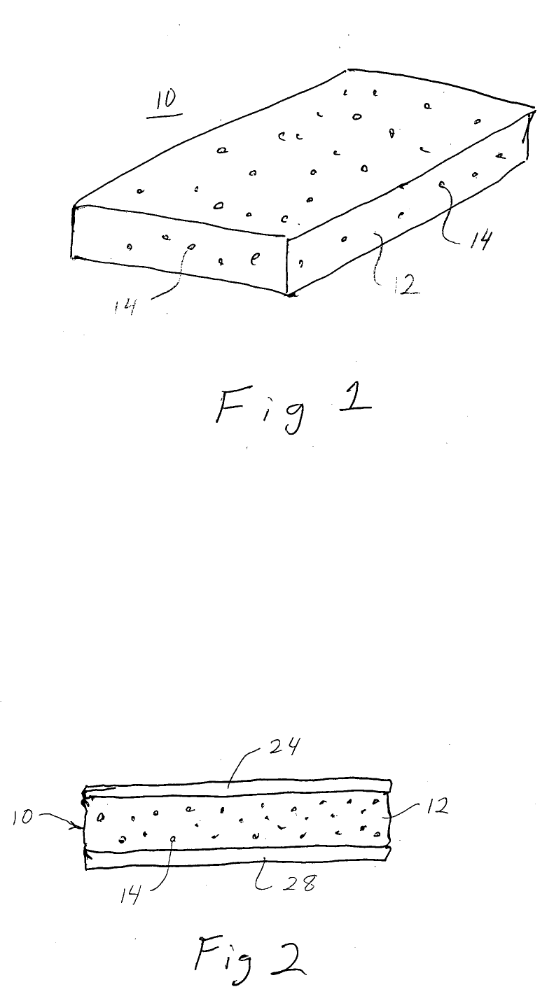

The light emitting composite material 10 according to the invention can be used to make many different light emitting devices. There is shown in FIG. 2 a light emitting device 20 in which the light emitting composite material 10 is provided with an anode 24 and a cathode 28 electrically connected thereto. The anode 24 and cathode 28 can generally be of any suitable electrically conductive material. At least one of the anode 24 and cathode 28 is substantially optically transparent at the second wavelength, such that light emitted by the light emitting material 10 is transmitted through the anode or cathode layers with minimal attenuation. As used herein, “substantially optically transparent” refers to a material which provides at least 85% transmission, and preferably at least 90% transmission for a 200 nm thick layer. Indium-tin oxide (ITO) is one such material which is suitable for use as a substantially optically transparent anode for a wavelength range of about 300 nm to 850 nm.

The cathode can be formed from materials including Ca, Al or Mg/Ag. In another embodiment, the cathode is formed from a substantially optically transparent material. In yet another embodiment, the cathode is formed from an optically reflective material, which can increase the light output of the device

The invention has application in most devices in which electroluminescent polymers have utility. Various configurations are possible to produce, for example, polymer light emitting diodes and other display devices.

FIG. 3 is a schematic depiction of a light emitting device 300 including separate electroluminescent polymer 330, nanoparticle 350, electron transport 340 and hole transport layers 320, according to an embodiment of the invention. Device 300 also includes anode 310 and cathode 360 which sandwich electroluminescent polymer 330, nanoparticle 350, electron transport 340 and hole transport layers 320. Although nanoparticle layer is shown in FIG. 3 as a separate layer, nanoparticles can be intermixed with one or more of electroluminescent polymer 330, electron transport 340 and hole transport layers 320. In this intermixed embodiment, the nanoparticles generally comprise 1 to 10 wt % of the overall mixed layer.

Transport layers provide at least two functions. Transport layers keep the charge carriers away from trapping sites at the electrodes, such that recombination occurs away from these trapping sites. In addition, transport layers can smooth an energy level transition between two layers by providing an intermediate energy level step between the energy levels of two otherwise adjacent layers.

For example, poly[3,4-(ethylenedioxy)thiophene]-poly(styrenesulfonic acid) (PEDOT/PSS) can be used as a hole transport layer 320 in some applications. PEDOT/PSS has an energy level of about 5 eV, vs. ITO glass preferably used as anode 310 which has an energy level of about 4.2 to 4.8 eV. Inorganics such as LiF or polymers such as poly(m-phenylene-vinylene-co-2,5-dioctyloxy-p-phenylene-vinylene) (PmPV) can be used as electron transport layer 340.

Polymers such as polysilane and substituted polysilanes provide good hole transport, but poor electron transport, Accordingly, if polymer 330 comprises a polysilane, hole transport layer 320 can be omitted generally without a degradation in performance of device, but electron transport layer is 340 is preferably included.

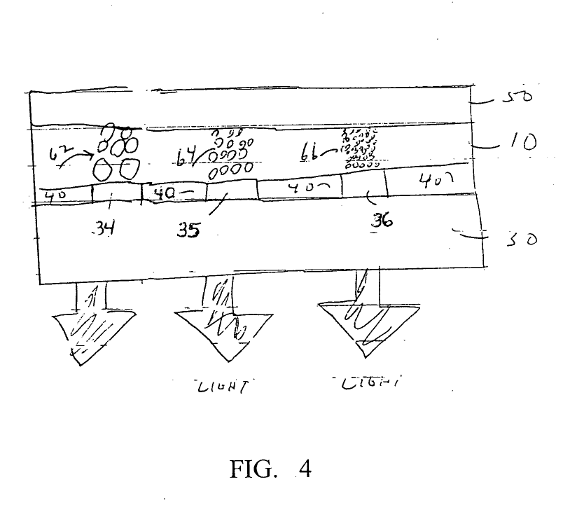

FIG. 4 shows an active display device in which a light emitting polymer composite 10 according to the invention is provided on an optically transparent substrate 30. Patterned electrodes 34, 35 and 36 are provided on the substrate 30. Electrically insulating material 40 separates each electrode 34 in the matrix. Light emitting composite material 10 according to the invention is provided over the electrodes 34-36, with large nanoparticles 62 overlying electrode 34, medium nanoparticles 64 overlying electrode 35, and small nanoparticles 66 overlying electrode 36. Another electrode 50 is applied to cap the assembly. The pixel comprising electrode 34 and nanoparticles 62 can provide red light, the pixel comprising electrode 35 and nanoparticles 64 can provide green light, while the pixel comprising electrode 36 and nanoparticles 66 can provide blue light. In this manner, the light emitting material 10 can be actively controlled as discrete pixels having different colors according to known principles. Many other constructions and fabrication methods are possible.

In one embodiment of the invention, a series of deposition, masking and etching steps are used to create pixels having different properties, such as different colors. A first nanoparticle size range can be blanket deposited on a substrate surface, such as on an electroluminescent polymer layer. Masking using conventional photolithography can be used to cover regions in which light having a color corresponding to nanoparticles in the first size range is desired, followed by an etching step, such as reactive ion etching (RIE). The mask regions protect nanoparticles thereunder during the etching step. The process is repeated by depositing nanoparticles of a second different size range corresponding to a second desired color, followed by masking the desired regions and an etch step. This process can clearly be repeated.

The light emitting material can be produced by many different methods. Discrete respective layers are generally deposited on one another. In the case of a layer comprising a polymer and nanoparticle mixture, the polymer can be first dissolved in a suitable solvent. The nanoparticles along with a dispersant can then be added. The mixture can then be spin cast as desired. Spin casting can produce a variety of different material, shapes, and dimensions. As noted above, photolithography techniques can be used to pattern the material.

This invention can be embodied in other forms without departing from the spirit or essential attributes thereof and, accordingly, reference should be had to the following claims, rather than to the foregoing specification, as indicating the scope of the invention.

1. A light emitting composite arrangement, comprising:
an electroluminescent polymer material, said electroluminescent polymer electroluminescing ultraviolet light, and
a plurality of photoluminescent nanoparticles energetically coupled to said electroluminescent polymer, said arrangement emitting red-shifted light relative to said ultraviolet light.

2. The composite of claim 1, wherein said electroluminescent polymer is a polysilane.

3. The composite of claim 2, wherein said polysilane is a substituted polysilane selected from the group consisting of monoalkyl polysilanes, dialkyl polysilanes, monoalkyl-aryl polysilanes, monoaryl polysilanes, and diaryl polysilanes.

4. The composite of claim 1, wherein said nanoparticles comprise at least one selected from the group consisting of CdSe, ZnS, CdS, ZnSe, ZnTe and CdTe.

5. The composite of claim 1, wherein said nanoparticles are intermixed with said polymer.

6. The composite of claim 1, wherein said nanoparticles a provided in a layer separated from said electroluminescent polymer.

7. The composite of claim 1, further comprising at least one of a hole transport layer and an electron transport layer, said energy transport layer energetically coupled to said electroluminescent polymer.

8. The composite of claim 1, wherein said nanoparticles comprise core-shell particles.

9. The composite of claim 8, wherein cores of said core-shell particles are selected from the group consisting of ZnS, ZnSe, ZnTe, CdS, CdSe and CdTe and shells of said core-shell particles are selected from the group consisting of ZnS, ZnSe, ZnTe, CdS, CdSe and CdTe.

10. A light emitting device, comprising:
an anode;
a cathode, and
a light emitting composite arrangement disposed between said anode and said cathode, said composite including an electroluminescent polymer material, said electroluminescent polymer electroluminescing ultraviolet light, and
a plurality of photoluminescent nanoparticles energetically coupled to said polymer, said device emitting red-shifted light relative to said ultraviolet light.

11. The device of claim 10, wherein said electroluminescent polymer is a polysilane.

12. The device of claim 11, wherein said polysilane is a substituted polysilane selected from the group consisting of monoalkyl polysilanes, dialkyl polysilanes, monoalkyl-aryl polysilanes, monoaryl polysilanes, and diaryl polysilanes.

13. The device of claim 10, wherein said nanoparticles comprise at least one selected from the group consisting of CdSe, ZnS, ZnSe, ZnTe, CdS and CdTe.

14. The device of claim 10, further comprising at least one of a hole transport layer between said polymer and said anode and an electron transport layer between said polymer and said cathode.

15. The device of claim 10, wherein at least a portion of said nanoparticles are disposed in said hole transport layer or said electron transport layer.

16. The device of claim 10, wherein at least a portion of said nanoparticles are intermixed with said polymer.

17. The device of claim 10, wherein said anode comprises indium tin oxide (ITO) and said cathode comprises Ca, Al or Mg/Ag.

18. The device of claim 10, wherein said device comprises a plurality of pixels, said plurality of pixels including red, green and blue pixels.

19. The device of claim 10, wherein said nanoparticles comprise core-shell particles.

20. The device of claim 19, wherein cores of said core-shell particles are selected from the group consisting of ZnS, ZnSe, ZnTe, CdS, CdSe and CdTe and shells of said core-shell particles are selected from the group consisting of ZnS, ZnSe, ZnTe, CdS, CdSe and CdTe.
